(19) United States
(12) Patent Application Publication
(10) Pub. No.: US 2009/0314145 A1
(43) Pub. Date: Dec. 24, 2009

(54) METHOD FOR ELIMINATING ENGRAVING DEFECTS FROM A METAL FILM DEPOSITED ON A FLEXIBLE CARRIER

(75) Inventors: Jacqueline Bablet, Le Gua (FR); Mohamed Benwadih, Champigny-sur-Marne (FR)

Correspondence Address: MARJAMA MULDOON BLASIAK & SULLIVAN LLP, 250 SOUTH CLINTON STREET, SUITE 300, SYRACUSE, NY, 13202, US

(73) Assignee: Commissariat A L'Energie Atomique, Paris (FR)

(21) Appl. No.: 12/470,135

(22) Filed: May 21, 2009

(30) Foreign Application Priority Data
Jun. 23, 2008 (FR) FR 0854142

(51) Int. Cl. B26D 3/00; B44C 1/22

(52) U.S. Cl. 83/53

(57) ABSTRACT

The invention relates to a method for eliminating mask projection laser ablation engraving defects from a metal film deposited on a flexible carrier. According to the invention, the method comprises spraying onto said defects a liquid pressurized at between about 1500 PSI and about 3000 PSI.

### CROSS REFERENCE TO RELATED APPLICATIONS

This application claims priority under 35 U.S.C. §119 from French Patent Application No. 0854142 filed on Jun. 23, 2008 in the French Patent Office, the entire disclosure of which is incorporated herein by reference.

### FIELD OF THE INVENTION

The invention relates to the elimination of defects caused by laser ablation engraving from a metal film deposited on a flexible carrier.

### BACKGROUND OF THE INVENTION

To create metal patterns on the surface of a flexible carrier, such as a plastic film for example, a known method is to deposit thereon, for example by vapor deposition, a metal film between about ten and some hundred nanometers thick, and then to etch the deposited metal film using an excimer laser beam with an ultraviolet wavelength of between 157 and 408 nanometers, said pulsed beam being projected through a glass and aluminum mask that defines the patterns to be etched.

It is noted however that this type of engraving, more commonly referred to by the phrase “mask projection laser ablation engraving,” produces on the edges of the etched patterns defects that are detrimental to the quality of the end component. Indeed, the engraving edges generally come with metal beads caused by the metal film melting under the effect of the laser, or with disbonded metal that forms overhangs, said overhanging disbonded metal usually being known as “caps,” said overhangs possibly measuring between 200 nanometers and 10 micrometers.

The appearance of these defects is inherent in excimer laser engraving and is explained by the fact that the heat from the ultraviolet rays generated by the laser vaporizes the carrier on which the metal film is deposited, causing it to burst locally, this occurring irrespective of the metal material of which it is made.

And the etched component is generally used subsequently in microelectronic components and may be coated with other types of functional layers, such as a thin film of 100 nanometers or less, such as a semi-conductor film between 30 and 70 nanometers thick for example.

Depositing layers on a surface that has engraving defects of the bead or cap type does however pose a number of problems, such as for example electrical charge leakage, operational transfer problems, losses of facet, premature ageing, etc.

To overcome these drawbacks, the document Excimer ablation of ITO onflexible substrates for large format display applications>>, by Osman A. Ghandour et al., Photon Processing Microelectronics Photonics, SPIE, vol. 4637, pages 90-101, 2002, proposes spraying carbon dioxide snow over the etched surface of the component.

However, it is noted in this prior art method that cap pick-up is violent and uncontrolled, as can be seen in FIG. 10, page 101 of the aforementioned document. In the end, the metal film eventually peels and the engraving edge is spoilt.

### DETAILED DESCRIPTION OF THE INVENTION

The purpose of the present invention is to resolve the aforementioned problem by proposing a method for the effective elimination of engraving defects, and particularly caps, and which does not damage the engraving edges.

To this end, the object of the invention is a method for eliminating mask projection laser ablation engraving defects from a metal film deposited on a flexible carrier, made to advantage of a plastic material, such as PEN (polyethylene naphtalate), PET (polyethylene terephthalate), polyimide.

A flexible substrate or carrier is taken to mean any substrate capable of assuming shapes and returning to its original position. This is particularly the case with plastic materials, which are constituted by carbon chains, and which form isolating films after extrusion.

According to the invention, the method comprises the spraying onto said defects of a liquid pressurized at between about 1500 PSI and about 3000 PSI.

In other words, the inventors have noticed that the effect of spraying a liquid at a correctly selected pressure is to eliminate substantially all the caps, while avoiding the phenomena whereby the metal film is disbanded and peels and the engraving edges are damaged.

It will be noted that effective and damage-free elimination, offering increased reproducibility of etched surface quality, means that the use of a sacrificial layer under and/or on the metal film to be etched can be avoided and also that the power associated with ablation can be reduced and that a quality engraving surface, i.e., without damaging the carrier, can therefore be guaranteed.

According to one particular inventive embodiment, the spray is applied at an angle above or equal to 300 with the surface, and even substantially perpendicular thereto. Under these conditions, all the caps, whatever the orientation thereof, can be eliminated.

According to one particular inventive embodiment, the liquid is de-ionized water.

In other words, the jet of de-ionized water is chemically innoxious for the metal film, does not therefore impair its surface, and in particular its roughness. Additionally, because of the way it is produced, de-ionized water comprises no residues and does not therefore contaminate the component. Lastly, no charge is created on the surface thereof.

If, moreover, the surface for preparation comprises electronic circuits, it is advantageous to re-ionize this de-ionized water to prevent electrostatic charge phenomena on the circuits, which may well damage them. Re-ionized water therefore has the advantages of ionized water associated with an electrical characteristic.

Other types of liquid are possible. To advantage, alcohol or acetone is used when component surface cleaning is also required.

According to one particular inventive embodiment, liquid is sprayed in a rotary and reciprocating motion relative to the metal film.

Thus, the etched surface is covered effectively by the liquid jet and the residues are swept away from it. Indeed, the rotation associated with the selected angle allows the caps to be attacked from every angle, thereby removing them.

According to one particular inventive embodiment, the pressure of the liquid is below about 1800 PSI when the metal film has been deposited by vapor deposition on the flexible carrier.

In other words, metal vapor deposition, using the so-called “Joule effect” technique or by electron gun for example, induces reduced adhesion of the metal film on the flexible carrier. The use of pressure below 1800 PSI but above 1500 PSI prevents the edges of the etched patterns from being torn off while maintaining a high degree of cap elimination.

For metal films that bond more firmly to the flexible carrier, such as those deposited by cathode sputtering for example, higher pressure can be used to increase cap elimination efficiency. Additionally, the number of times the high pressure liquid is sprayed can be increased with no risk of damaging the etched patterns. For example, the number of sprays can be tripled relative to metal films with low bond strength.

It will be noted that the thickness and nature of the materials in the deposited metal film (Cu, NiPd, Pt, Au or the like) have substantially no effect on elimination efficiency, the main factor influencing this being the bond strength.

The inventive method is for example implemented using a standard particle cleaning device as used in the field of micro-electronics. Said device commonly comprises a rotary holder to receive the component for cleaning, an articulated arm capable of performing reciprocating motions and fitted with a nozzle with a diameter of about 30 micrometers. The device also comprises a pressurized liquid circuit supplying the nozzle, the latter being pointed substantially perpendicular to the component to be cleaned. During a conventional use of such a device, i.e. for cleaning, the pressure of the liquid is roughly between 1200 and 1500 PSI.

According to the invention, said prior art device is used in another pressure range, namely to operate at liquid pressures of between about 1500 PSI and about 3000 PSI with a nozzle located at a distance of some ten millimeters from the surface of the component from which the defects have to be eliminated.

1. A method for eliminating mask projection laser ablation engraving defects from a metal film deposited on a flexible carrier, the method comprising spraying onto said defects, a liquid pressurized at between about 1500 PSI and about 3000 PSI.

2. The method as claimed in claim 1, wherein the liquid is sprayed at an angle greater than or equal to 30° with the metal film.

3. The method as claimed in claim 2, wherein the liquid is sprayed substantially perpendicular to the metal film.

4. The method as claimed in claim 1, wherein the sprayed liquid is de-ionized water.

5. The method as claimed in claim 4, wherein the de-ionized water is re-ionized before it is used.

6. The method as claimed in claim 1, wherein the liquid is sprayed in a rotary and reciprocating motion relative to the metal film.

7. The method as claimed in claim 1, wherein the liquid pressure is below about 1800 PSI when the metal film has been deposited by vapour deposition on the flexible carrier.

8. The method as claimed in claim 1, wherein the flexible carrier is made out of a plastic material.

9. The method as claimed in claim 8, wherein the flexible carrier is made out of a material selected from the group consisting of PEN (polyethylene naphtalate), PET (polyethylene terephtalate) and polyimide.
